(19) United States
(12) Patent Application Publication
(10) Pub. No.: US 2023/0027222 A1
(43) Pub. Date: Jan. 26, 2023

(54) ELECTRONIC DEVICE FOR MANAGING INAPPROPRIATE ANSWER AND OPERATING METHOD THEREOF

(71) Applicant: Samsung Electronics Co., Ltd., Suwon-si (KR)

(72) Inventors: Sijun LEE, Suwon-si (KR); Suneung PARK, Suwon-si (KR); Seongrok LEE, Suwon-si (KR); Jiyong LEE, Suwon-si (KR); Changyong JEON, Suwon-si (KR)

(21) Appl. No.: 17/870,246

(22) Filed: Jul. 21, 2022

Related U.S. Application Data
(63) Continuation of application No. PCT/KR2022/010434, filed on Jul. 18, 2022.

(30) Foreign Application Priority Data
Jul. 26, 2021 (KR) 10-2021-0097844

(51) Int. Cl. G06F 40/263; G06F 40/279

(52) U.S. Cl. CPC G06F 40/263; G06F 40/279

(57) ABSTRACT

An electronic device is provided. The electronic device includes processor, and a memory that stores instructions. The instructions, when executed by the processor, cause the electronic device to receive a user input, to identify a natural language input corresponding to the user input, to identify a first natural language output corresponding to the natural language input, to identify at least one specified word from at least one word included in the first natural language output, to identify a second natural language output based on a fact that the at least one specified word is identified, and to output the second natural language output such that the second natural language output is provided to a user.

### CROSS-REFERENCE TO RELATED APPLICATION(S)

This application is a continuation application, claiming priority under § 365(c), of an International application No. PCT/KR2022/010434, filed on Jul. 18, 2022, which is based on and claims the benefit of a Korean patent application number 10-2021-0097844, filed on Jul. 26, 2021, in the Korean Intellectual Property Office, the disclosure of which is incorporated by reference herein in its entirety.

### TECHNICAL FIELD

The disclosure relates to an electronic device that manages an inappropriate answer, and an operating method thereof.

### BACKGROUND ART

A voice assistant service may include a technology for grasping a user's intent based on the user's utterance and providing the user with a service corresponding to the intent.

As such, artificial intelligence (AI) technology may be utilized when the intent included in the user's voice input is grasped in a voice assistant service. In addition, a rule-based Natural Language Understanding (NLU) technology may be utilized.

An electronic device providing the voice assistant service may perform an operation corresponding to the grasped intent and may provide the user with an answer to the user's utterance.

### DISCLOSURE

### Technical Problem

When providing a voice assistant service, an electronic device may generate an answer to a user's utterance.

At this time, the electronic device may generate an answer to the utterance based on the user's utterance, a pre-stored response message, data generated by the user, a web search result, an open source database, or a combination thereof.

As such, the answer generated by the electronic device may include an inappropriate vocabulary. When an answer including the inappropriate vocabulary is provided to the user, the user may experience discomfort.

### Technical Solution

In accordance with an aspect of the disclosure, an electronic device is provided. The electronic device includes at least one processor, and a memory that stores instructions. The instructions, when executed by the at least one processor, may cause the electronic device to receive a user input, to identify a natural language input corresponding to the user input, to identify a first natural language output corresponding to the natural language input, to identify at least one specified word from at least one word included in the first natural language output, to identify a second natural language output based on a fact that the at least one specified word is identified, and to output the second natural language output such that the second natural language output is provided to a user.

In accordance with an aspect of the disclosure, an operating method of an electronic device is provided. The method includes receiving a user input, identifying a natural language input corresponding to the user input, identifying a first natural language output corresponding to the natural language input, identifying at least one specified word from at least one word included in the first natural language output, identifying a second natural language output based on a fact that the at least one specified word is identified, and outputting the second natural language output such that the second natural language output is provided to a user.

The technical problems to be solved by various embodiments of the disclosure are not limited to the aforementioned problem, and other technical problems that are not mentioned will be clearly understood by those skilled in the art, to which the disclosure pertains, from the following description.

### Advantageous Effects

According to various embodiments disclosed in the specification, when an inappropriate vocabulary is included in an answer generated by an electronic device, another alternative answer may be provided to a user.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

FIG. 1 is a block diagram of an electronic device in a network environment, according to an embodiment of the disclosure;

FIG. 2 is a block diagram illustrating an electronic device, according to an embodiment of the disclosure;

FIG. 3 is a flowchart illustrating an operation of an electronic device, according to an embodiment of the disclosure;

FIG. 4 is a flowchart illustrating an operation of an electronic device, according to an embodiment of the disclosure;

FIG. 5 is a flowchart illustrating an operation of an electronic device, according to an embodiment of the disclosure;

FIG. 6A is a diagram illustrating a response of an electronic device, according to an embodiment of the disclosure;

FIG. 6B is a diagram illustrating a response according to different slang processing methods of an electronic device, according to an embodiment of the disclosure;

FIG. 7 is a block diagram illustrating an integrated intelligence system, according to an embodiment of the disclosure;

FIG. 8 is a diagram illustrating a form in which relationship information between a concept and an action is stored in a database, according to an embodiment of the disclosure; and

FIG. 9 is a view illustrating a screen in which a user terminal processes a voice input received through an intelligence app, according to an embodiment of the disclosure;

Throughout the drawings, it should be noted that like reference numbers are used to depict the same or similar elements, features, and structures.

### MODE FOR INVENTION

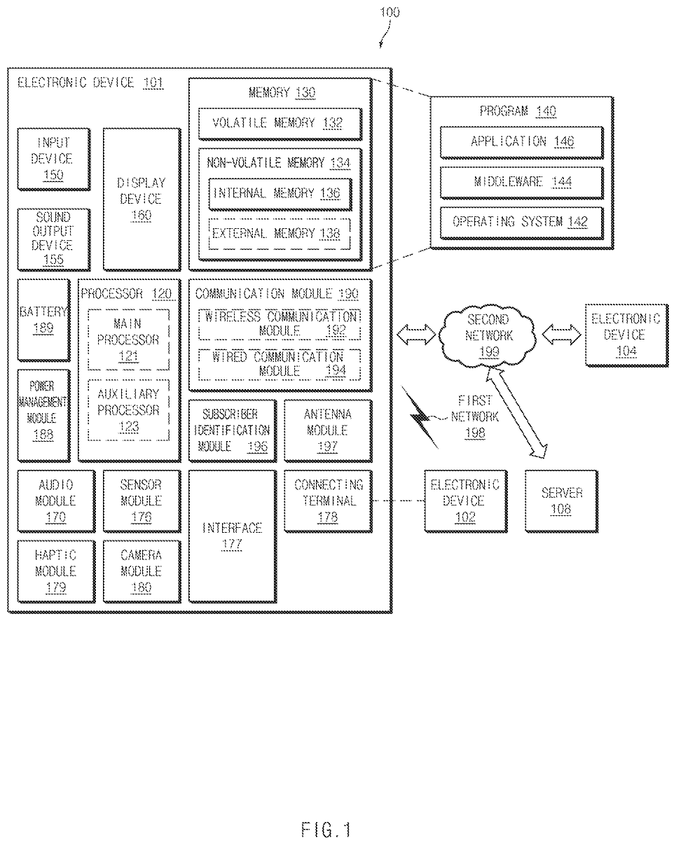

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

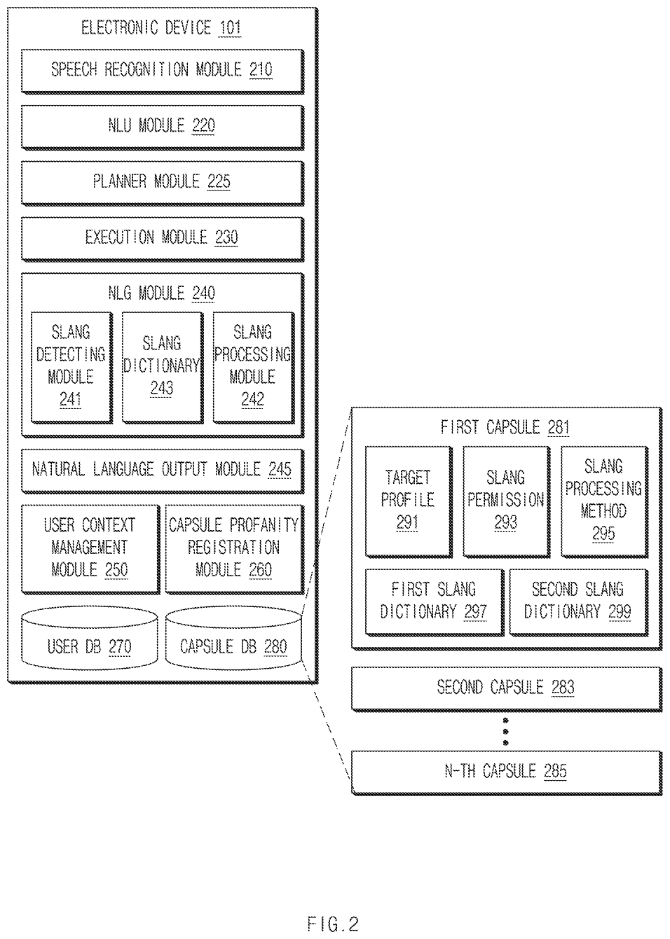

FIG. 2 is a block diagram illustrating the electronic device 101, according to an embodiment of the disclosure.

The electronic device 101 of FIG. 2 may include at least one of configurations of the electronic device 101 of FIG. 1.

Referring to FIG. 2, the electronic device 101 may include a speech recognition module 210, an NLU module 220, a planner module 225, an execution module 230, a natural language generator (NLG) module 240, a natural language output module 245, a user context management module 250, a capsule profanity registration module 260, a user database (DB) 270, a capsule DB 280, or a combination thereof. In an embodiment, at least some of the components of the electronic device 101 of FIG. 2 may be implemented with software. The classification of configurations of the electronic device 101 of FIG. 2 is logical, and at least some of the configurations of the electronic device 101 may be implemented with one piece of software.

In an embodiment, the speech recognition module 210 may obtain a voice signal through the audio module 170 (e.g., a microphone). In an embodiment, the voice signal may also be referred to as a “user input”.

In an embodiment, the speech recognition module 210 may convert the obtained voice signal into text data. In an embodiment, the speech recognition module 210 may convert the user's utterance included in the voice signal into text data. In an embodiment, the text data converted by the speech recognition module 210 may also be referred to as a “natural language input”.

In an embodiment, the speech recognition module 210 may transmit the converted text data to the NLU module 220.

In an embodiment, the NLU module 220 may obtain text data (or a natural language input) through the speech recognition module 210. In an embodiment, the NLU module 220 may obtain text data (or a natural language input) through the input module 150 (e.g., a touch screen or a keyboard).

In an embodiment, the NLU module 220 may grasp a user's intent by using the text data. For example, the NLU module 220 may grasp the intent of the user by performing syntactic analysis or semantic analysis on the text data. In an embodiment, the NLU module 220 may grasp the meaning of words extracted from the text input by using linguistic features (e.g., syntactic elements) such as morphemes or phrases and then may determine the intent of the user by matching the grasped meaning of the words to the intent.

For example, when the text data saying that “redial the phone number I just called” is entered, the NLU module 220 may determine that “call” or “redial” is intent. In an embodiment, a part of the intent may be a goal (e.g., “redial”).

In an embodiment, the NLU module 220 may deliver the determined intent (or a parameter indicating the intent) to the planner module 225.

In an embodiment, the planner module 225 may generate a plan by using the intent (or a parameter indicating intent). In an embodiment, the planner module 225 may generate a plan including a plurality of actions and/or a plurality of concepts by using the intent (or a parameter indicating the intent). In an embodiment, a parameter and a result value output by performing a plurality of actions may be defined as a concept having a specified type (or class).

In an embodiment, the planner module 225 may generate a plan by stepwise (or hierarchically) determining relationships between a plurality of actions and a plurality of concepts. For example, the planner module 225 may generate a plan by determining an execution order of a plurality of actions based on a plurality of concepts. In an embodiment, the planner module 225 may generate a plan by determining the execution order of a plurality of actions based on parameters necessary to perform a plurality of actions and/or results output by performing the plurality of actions. In an embodiment, the planner module 225 may generate a plan including relationship information (e.g., ontology) between a plurality of actions and a plurality of concepts.

In an embodiment, the planner module 225 may generate a plan by using the capsule DB 280 storing a set of relationships between concepts and actions. In an embodiment, the planner module 225 may generate a plan by using a capsule associated with the intent (or a parameter indicating intent) among a plurality of capsules (281, 283, 285) included in the capsule DB 280. In an embodiment, the planner module 225 may generate a plan by using a plurality of concepts and a plurality of actions, which are included in a capsule associated with the intent (or a parameter indicating the intent).

In an embodiment, the planner module 225 may deliver the generated plan to the execution module 230.

In an embodiment, the execution module 230 may calculate a result by using the generated plan. In an embodiment, the execution module 230 may calculate the result by performing a plurality of actions by using the generated plan. For example, when a plan is generated based on the intent of “call” or “redial”, the execution module 230 may make a call to the phone number of the previously-called counterpart by using a phone application.

In an embodiment, the NLG module 240 may include a slang detecting module 241 and/or a slang processing module 243.

In an embodiment, the NLG module 240 may generate text data corresponding to a user input and/or a natural language input. In an embodiment, the NLG module 240 may generate text data based on an output (intent (or a parameter indicating the intent)) of the NLU module 220, and/or the output (plan) of the planner module 225. In an embodiment, the NLG module 240 may generate text data for indicating whether to perform a plan generated according to a user input and/or a natural language input. In an embodiment, the text data generated by the NLG module 240 may also be referred to as a “first natural language output”.

For example, the NLG module 240 may generate text data “I'll call the phone number that you just called” in response to the user utterance saying that “redial the phone number I just called”. As another example, the NLG module 240 may generate text data saying “I'll call a son of a bitch in Maetan-dong” in response to the user utterance “redial the phone number I just called”. Herein, the “son of a bitch in Maetan-dong” may be a name, which is stored in an address book and which indicates a counterpart whom I just called.

In an embodiment, the slang detecting module 241 may identify whether to permit a slang word. In an embodiment, the slang detecting module 241 may determine whether a user permits the use of the slang word, with reference to the user DB 270. In an embodiment, the slang detecting module 241 may determine whether a slang word of the capsule is permitted, with reference to the capsule DB 280. In an embodiment, the slang detecting module 241 may determine whether the slang word of the capsule is permitted, based on the generated plan. In an embodiment, the slang detecting module 241 may determine whether the slang word of the capsule associated with the generated plan is permitted. In an embodiment, the generated plan may be a plan generated based on a natural language input. For example, the slang detecting module 241 may determine whether the slang word of the first capsule 281 is permitted, based on slang permission information 293 of the first capsule 281.

In an embodiment, the slang detecting module 241 may determine whether a user is a slang policy target. In an embodiment, when the slang word is not permitted, the slang detecting module 241 may determine whether the user is a slang policy target.

In an embodiment, the slang detecting module 241 may determine whether the user is a slang policy target, based on the capsule DB 280. In an embodiment, the slang detecting module 241 may determine whether the user is a slang policy target, based on target profile information 291 of a capsule (e.g., the first capsule 281) that is based on the generated plan. In an embodiment, the slang detecting module 241 may determine whether the user is a slang policy target, based on the target profile information 291 of a capsule (e.g., the first capsule 281) associated with the generated plan. In an embodiment, the slang detecting module 241 may determine whether the user is a target of the slang policy of the capsule. For example, when the first capsule 281 is included in the generated plan, the slang detecting module 241 may identify a target of the slang policy of the capsule of the first capsule 281 based on the target profile information 291 of the first capsule 281. In an embodiment, the target profile information 291 may include information about an age at which a slang word is permitted and/or an age at which a slang word is not permitted. For example, when the first capsule 281 including the target profile information 291 is included in a plan, a user under the age of 18 may be set not to permit the use of a slang word. When a user is under the age of 18, the slang detecting module 241 may identify that the user is the target of the slang policy of the first capsule 281.

In an embodiment, the target profile information 291 may be stored by subdividing the target of a slang policy of a capsule. For example, the target profile information 291 may be classified into a first age group (e.g., 18 years or older), a second age group (e.g., 12 years or older and less than 18 years old), a third age group (e.g., 6 years or older and less than 12 years old), or a fourth age group (e.g., less than 6 years old); and, the target profile information 291 may define slang words permitted for each age group and slang words not permitted for each age group. For example, a slang word of a “son of a bitch” may be permitted in the first age group, but may not be permitted in the second, third, and fourth age groups.

In an embodiment, the slang detecting module 241 may detect a specified slang word from text data (a first natural language output) generated by the NLG module 240. In an embodiment, when the user is a slang policy target, the slang detecting module 241 may detect the specified slang word from text data (the first natural language output) generated by the NLG module 240. In an embodiment, when a slang word is not permitted, the slang detecting module 241 may detect the specified slang word from the text data (the first natural language output) generated by the NLG module 240.

In an embodiment, the specified slang word may be a slang word registered in a slang dictionary. In an embodiment, the specified slang word may be the slang word registered in the slang dictionary of the capsule DB 280. In an embodiment, the specified slang word may be the slang word registered in a slang dictionary (297, 299) of a capsule (e.g., the first capsule 281) included in the generated plan. In an embodiment, the specified slang may be the slang word registered in a slang dictionary 242 managed by the NLG module 240.

In an embodiment, the slang detecting module 241 may detect the specified slang word from the first natural language output based on the capsule DB 280. In an embodiment, the slang detecting module 241 may detect the specified slang word from the first natural language output based on the slang dictionary (297, 299) of the capsule (e.g., the first capsule 281) included in the generated plan. For example, when the first capsule 281 is included in the generated plan, the slang detecting module 241 may detect the specified slang word from the first natural language output by using the first slang dictionary 297 and/or the second slang dictionary 299 of the first capsule 281. In an embodiment, the slang detecting module 241 may also detect the specified slang word from the first natural language output based on the slang dictionary 242 managed by the NLG module 240.

In an embodiment, the first slang dictionary 297 may include a list of slang words permitted by the first capsule 281. In an embodiment, the list of slang words permitted by the first capsule 281 may include a list of names of content (e.g., music, a movie, or a book). In an embodiment, the second slang dictionary 299 may include a list of slang words not permitted by the first capsule 281. In an embodiment, the first slang dictionary 297 and/or the second slang dictionary 299 may be updated as the first capsule 281 is updated. In an embodiment, the first slang dictionary 297 and/or the second slang dictionary 299 may be updated based on a user input. For example, on the basis of a user input entered based on a user interface (UI), the electronic device 101 may add a slang word to the first slang dictionary 297 and/or may delete a slang word from the first slang dictionary 297. As another example, on the basis of a user input entered based on a UI, the electronic device 101 may add a slang word to the second slang dictionary 299 and/or may delete a slang word from the second slang dictionary 299. As another example, the first slang dictionary 297 and/or the second slang dictionary 299 may be updated by a server (e.g., the server 108) providing the first capsule 281.

In an embodiment, the first slang dictionary 297 and/or the second slang dictionary 299 may be set depending on a slang permission level. In an embodiment, the permission level of a slang word may indicate whether to permit a respective slang word. In an embodiment, the permission level of a slang word may be divided from the lowest level at which a slang word is the narrowest level to the highest level at which a slang word is permitted at the widest level. In an embodiment, there may be at least one or more intermediate levels between the lowest level and the highest level. For example, an arbitrary slang word (e.g., a “son of a bitch”) may not be permitted at a first level among the intermediate levels, but may be permitted at a second level that is the next level of the first level.

In an embodiment, the slang dictionary 242 managed by the NLG module 240 may include a list of slang words set in a dictionary. In an embodiment, the list of slang words included in the slang dictionary 242 may be updated based on a user input.

In an embodiment, when there are two or more capsules included in a plan, the slang detecting module 241 may determine whether words included in the first natural language output are slang words, based on each of the two or more capsules. For example, when the first natural language output is “I will send a text message that I am listening to Ahn Chi-hwan's ‘sons of a bitch’, to a son of a bitch in Maetan-dong”, the slang detecting module 241 may identify that a “son of a bitch” and “sons of a bitch” are slang words.

In an embodiment, when the first word among words included in the first natural language output is identified as a slang word based on all the two or more capsules, the slang detecting module 241 may identify that the first word is a slang word. In an embodiment, when the first word among words included in the first natural language output is identified as a slang word based on at least one of the two or more capsules, the slang detecting module 241 may identify that the first word is a slang word.

In an embodiment, when there are two or more capsules included in the plan, the slang detecting module 241 may determine whether a word, which is associated with each of the two or more capsules, from among words included in the first natural language output is a slang word, based on a capsule included in the plan. For example, the slang detecting module 241 may identify that a “son of a bitch” is a slang word, based on an address book-related capsule (e.g., the first capsule 281); and, the slang detecting module 241 may identify that “sons of a bitch” are slang words, based on a music-related capsule (e.g., the second capsule 283).

In an embodiment, the slang processing module 243 may process the slang word detected from the first natural language output. In an embodiment, the slang processing module 243 may process the slang word detected from the first natural language output with reference to the capsule DB 280. For example, when the first capsule 281 is included in the generated plan, the slang processing module 243 may process the slang word detected from the first natural language output based on a slang processing method information 295 of the first capsule 281. In an embodiment, the slang processing method information 295 may include information about a method for processing a specified slang word. In an embodiment, the method for processing a slang word may include replacement of a slang word, screening for a slang word, deletion of a slang word, or a combination thereof. For example, the slang processing method information 295 may define a method for changing the slang word detected from the first natural language output into an alternative expression for the corresponding slang word. For example, the slang processing method information 295 may define a method for changing the slang word detected from the first natural language output into a specified character (e.g., asterisk (*)). For example, the slang processing method information 295 may define a method for omitting the slang word detected from the first natural language output.

In an embodiment, the slang processing module 243 may process the detected slang word based on the capsule associated with the slang word detected from the first natural language output. For example, when the first natural language output is “I will send a text message that I am listening to Ahn Chi-hwan's ‘sons of a bitch’, to a son of a bitch in Maetan-dong”, the slang processing module 243 may process a “son of a bitch” based on an address book-related capsule (e.g., the first capsule 281) and may process “sons of a bitch” based on a music-related capsule (e.g., the second capsule 283). For example, when the address book-related capsule (e.g., the first capsule 281) does not permit a slang word, and the music-related capsule (e.g., the second capsule 283) permits a slang word, the slang processing module 243 may generate a second natural language output saying that “I will send a text message that I am listening to Ahn Chi-hwan's ‘sons of a bitch’, to a gae** in Maetan-dong”.

In an embodiment, when the slang word detected from the first natural language output is associated with two or more capsules, the slang processing module 243 may process the detected slang word based on whether each of two or more capsules permits the detected slang word. In an embodiment, when all of the two or more capsules for the detected slang word do not permit the corresponding slang word, the slang processing module 243 may process the detected slang word. In an embodiment, when a capsule, which has a specified ratio (e.g., 50%), from among the two or more capsules for the detected slang word does not permit the corresponding slang word, the slang processing module 243 may process the detected slang word. In an embodiment, when at least one capsule among two or more capsules for the detected slang word permits the corresponding slang word, the slang processing module 243 may not process the detected slang word.

In an embodiment, the slang processing module 243 may differently process a slang word depending on the type of a word detected as a slang word from the first natural language output. In an embodiment, when the word detected as a slang word is a proper noun (e.g., the name of content), the slang processing module 243 may not process a word, which is detected as a slang word, as a slang word. In an embodiment, when the word detected as a slang word is a user-defined noun (e.g., the name of the address book), the slang processing module 243 may process a word, which is detected as a slang word, as a slang word.

In an embodiment, the natural language output module 245 may provide the user with one of a first natural language output or a second natural language output. In an embodiment, the natural language output module 245 may provide the user with one of the first natural language output or the second natural language output through the display module 160 and/or the audio module 170.

In an embodiment, the user context management module 250 may manage the user DB 270. In an embodiment, the user context management module 250 may update whether the user permits a slang word, based on a user request. In an embodiment, the user DB 270 may include information indicating whether the user permits a slang word.

In an embodiment, the capsule profanity registration module 260 may manage the capsule DB 280. In an embodiment, the capsule profanity registration module 260 may add a slang word to a capsule's slang dictionary, and/or may delete a slang word from the capsule's slang dictionary.

In an embodiment, the capsule DB 280 may store information about the relationship between actions and a plurality of concepts corresponding to a plurality of domains. In an embodiment, the capsule (281, 283, 285) may include a plurality of action objects (or action information) and/or concept objects (or concept information) included in the plan. In an embodiment, the capsule DB 280 may store the plurality of capsules (281, 283, 285) in a form of a concept action network (CAN).

In an embodiment, the capsules (281, 283, 285) may be associated with different actions (or functions) from one another. For example, the first capsule 281 may be an address book-related capsule. In an embodiment, the first capsule 281 may store information about actions associated with a function (e.g., searching for contacts stored in an address book, making calls to contacts, and/or searching for phone records with contacts) of an address book-related application. As another example, the second capsule 283 may be a music-related capsule. In an embodiment, the second capsule 283 may store information about actions related to a function (e.g., searching for music, and/or playing music) of a music-related application. As another example, in an embodiment, the n-th capsule 285 may be an image-related capsule. In an embodiment, the n-th capsule 285 may store information about actions related to a function (e.g., searching for an image, and/or playing an image) of an image-related application.

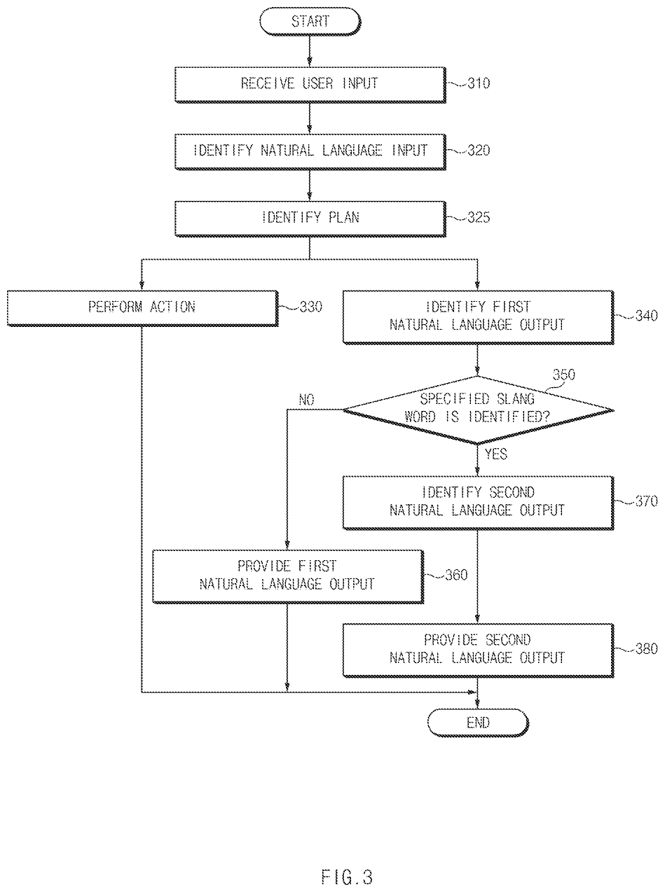

FIG. 3 is a flowchart illustrating an operation of the electronic device 101, according to an embodiment of the disclosure. The operations of FIG. 3 may be performed through configurations of the electronic device 101 of FIG. 2.

Referring to FIG. 3, in operation 310, the electronic device 101 may receive a user input. In an embodiment, the electronic device 101 may receive a user input through the audio module 170 (e.g., a microphone) and/or the input module 150 (e.g., a touch screen or a keyboard). In an embodiment, the user input may include a voice input and/or a text input.

In operation 320, the electronic device 101 may identify a natural language input. In an embodiment, the electronic device 101 may identify the natural language input by converting a user input into text data.

In operation 325, the electronic device 101 may identify a plan. In an embodiment, the electronic device 101 may identify a user's intent (or a parameter indicating the intent) from the natural language input and may identify the plan based on the grasped intent.

In operation 330, the electronic device 101 may perform an action. In an embodiment, the electronic device 101 may perform the action defined in the plan.

In operation 340, the electronic device 101 may identify a first natural language output. In an embodiment, the electronic device 101 may generate the first natural language output corresponding to the user input. In an embodiment, the electronic device 101 may generate the first natural language output based on the intent (or a parameter indicating the intent) of the user input and/or a plan. In an embodiment, the first natural language output may indicate whether to execute the plan according to the user input.

In operation 350, the electronic device 101 may determine whether the specified slang word is identified in the first natural language output. In an embodiment, the electronic device 101 may determine whether a slang word is not permitted. When the slang word is not permitted, the electronic device 101 may determine whether the specified slang word is identified in the first natural language output. In an embodiment, the electronic device 101 may determine whether a user is a target of a slang policy. When the user is the target of the slang policy, the electronic device 101 may determine whether the specified slang word is identified in the first natural language output.

In an embodiment, the electronic device 101 may determine whether the specified slang word is identified in the first natural language output, based on the capsule included in a plan. In an embodiment, the electronic device 101 may determine whether the specified slang word is identified in the first natural language output, based on a slang dictionary defined by the capsule included in the plan.

In an embodiment, the electronic device 101 may determine whether the specified slang word is identified in the first natural language output, based on the capsule included in a plan.

In an embodiment, the electronic device 101 may determine whether words included in the first natural language output are slang words, based on each of the two or more capsules. In an embodiment, the electronic device 101 may determine whether a word, which is associated with each of the two or more capsules, from among words included in the first natural language output is a slang word, based on a capsule included in the plan.

In an embodiment, when the specified slang word is not identified in the first natural language output (it is determined as “no”), the electronic device 101 may perform operation 360. In an embodiment, when the specified slang word is identified in the first natural language output (it is determined as “yes”), the electronic device 101 may perform operation 370.

In operation 360, the electronic device 101 may provide the first natural language output. In an embodiment, the electronic device 101 may provide the first natural language output to the user through the display module 160 and/or the audio module 170 (e.g., a speaker).

In operation 370, the electronic device 101 may identify a second natural language output. In an embodiment, the electronic device 101 may identify the second natural language output by processing the slang word detected from the first natural language output. In an embodiment, the electronic device 101 may identify the second natural language output by processing the slang word detected from the first natural language output based on a method for processing the slang word defined by the capsule included in the plan. In an embodiment, the method for processing a slang word may include replacement of a slang word, screening for a slang word, deletion of a slang word, or a combination thereof.

In an embodiment, the electronic device 101 may process the detected slang word based on the capsule associated with the slang word detected from the first natural language output.

In an embodiment, when the slang word detected from the first natural language output is associated with two or more capsules, the electronic device 101 may process the detected slang word based on whether each of two or more capsules permits the detected slang word. In an embodiment, when all of the two or more capsules for the detected slang word do not permit the corresponding slang word, the slang processing module 243 may process the detected slang word. In an embodiment, when a capsule, which has a specified ratio (e.g., 50%), from among the two or more capsules for the detected slang word does not permit the corresponding slang word, the slang processing module 243 may process the detected slang word. In an embodiment, when at least one capsule among two or more capsules for the detected slang word permits the corresponding slang word, the slang processing module 243 may not process the detected slang word.

In operation 380, the electronic device 101 may provide the second natural language output. In an embodiment, the electronic device 101 may provide the second natural language output to the user through the display module 160 and/or the audio module 170 (e.g., a speaker).

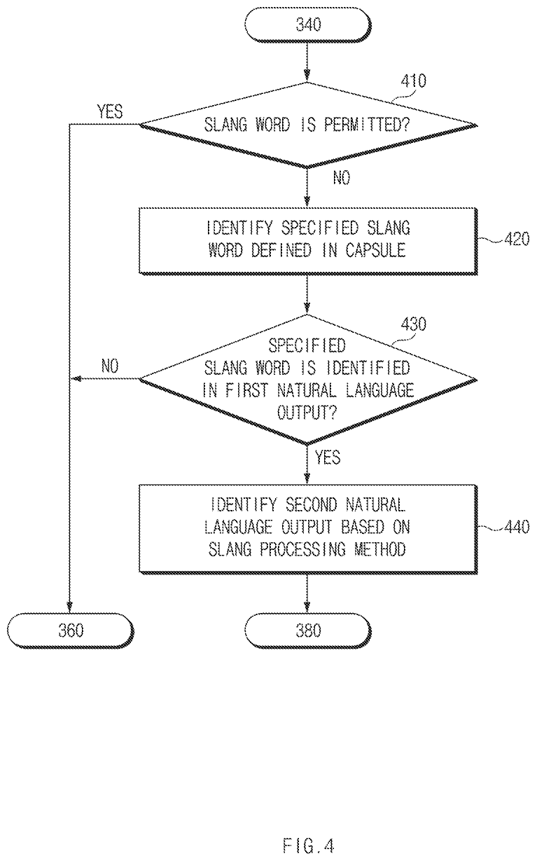

FIG. 4 is a flowchart illustrating an operation of the electronic device 101, according to an embodiment of the disclosure. Operations of FIG. 4 may be included in operation 350 and operation 370 of FIG. 3. The operations of FIG. 4 may be performed through configurations of the electronic device 101 of FIG. 2.

In operation 410, the electronic device 101 may determine whether a slang word is permitted. In an embodiment, the electronic device 101 may determine whether a user permits the use of the slang word, with reference to the user DB 270. In an embodiment, the electronic device 101 may determine whether a slang word of the capsule is permitted, with reference to the capsule DB 280. In an embodiment, the electronic device 101 may determine whether the slang word of the capsule included in the generated plan is permitted.

In an embodiment, when the slang word is permitted (it is determined as “yes”), the electronic device 101 may perform operation 360. In an embodiment, when the slang word is not permitted (it is determined as “no”), the electronic device 101 may perform operation 420.

In operation 420, the electronic device 101 may identify the specified slang word defined in the capsule. In an embodiment, the specified slang word may be a slang word registered in a slang dictionary. In an embodiment, the slang dictionary may be managed in the capsule DB 280. In an embodiment, the slang dictionary may be managed in the user DB 270.

In operation 430, the electronic device 101 may determine whether the specified slang word is identified in the first natural language output.

In an embodiment, the electronic device 101 may determine whether the specified slang word is identified in the first natural language output, based on the capsule included in a plan.

In an embodiment, the electronic device 101 may determine whether words included in the first natural language output are slang words, based on each of the two or more capsules. In an embodiment, the electronic device 101 may determine whether a word, which is associated with each of the two or more capsules, from among words included in the first natural language output is a slang word, based on a capsule included in the plan.

In an embodiment, when the slang word is not identified (it is determined as “no”), the electronic device 101 may perform operation 360. In an embodiment, when the slang word is identified (it is determined as “yes”), the electronic device 101 may perform operation 440.

In operation 440, the electronic device 101 may identify a second natural language output based on the slang processing method. In an embodiment, operation 440 may correspond to operation 370.

In an embodiment, the electronic device 101 may process the detected slang word based on the capsule associated with the slang word detected from the first natural language output. In an embodiment, when the slang word detected from the first natural language output is associated with two or more capsules, the electronic device 101 may process the detected slang word based on whether each of two or more capsules permits the detected slang word.

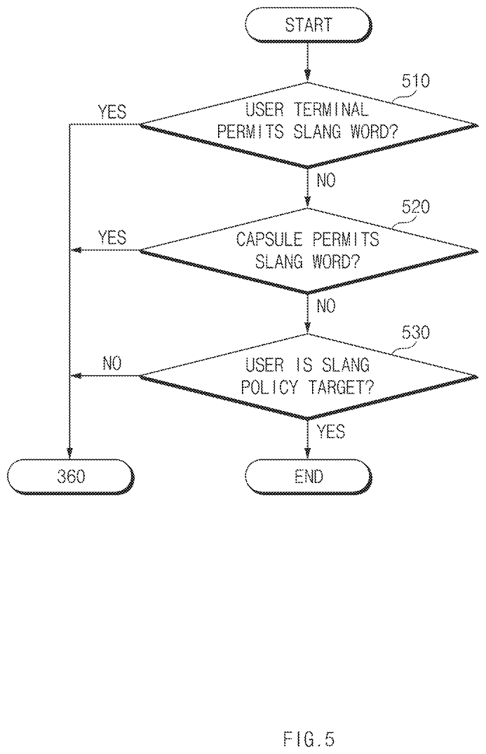

FIG. 5 is a flowchart illustrating an operation of the electronic device 101, according to an embodiment of the disclosure. Operations of FIG. 5 may be included in operation 410 of FIG. 4. The operations of FIG. 5 may be performed through configurations of the electronic device 101 of FIG. 2.

In operation 510, the electronic device 101 may determine whether a user permits a slang word. In an embodiment, the electronic device 101 may determine whether a user permits the use of the slang word, with reference to the user DB 270.

In an embodiment, when the user permits a slang word (it is determined as “yes”), the electronic device 101 may perform operation 360. In an embodiment, when the user does not permit a slang word (it is determined as “no”), the electronic device 101 may perform operation 520.

In operation 520, the electronic device 101 may determine whether a capsule permits a slang word. In an embodiment, the electronic device 101 may determine whether the capsule permits a slang word, based on the capsule DB 280. In an embodiment, the electronic device 101 may determine whether the capsule included in a plan (e.g., the first capsule 281) permits a slang word.

In an embodiment, when the capsule permits a slang word (it is determined as “yes”), the electronic device 101 may perform operation 360. In an embodiment, when the capsule does not permit a slang word (it is determined as “no”), the electronic device 101 may perform operation 530.

In operation 530, the electronic device 101 may determine whether the user is a slang policy target. In an embodiment, the electronic device 101 may determine whether the user is a slang policy target, based on the capsule DB 280. In an embodiment, the electronic device 101 may identify whether the user is a slang policy target, based on the target profile information 291 of the capsule (e.g., the first capsule 281) included in the generated plan.

In an embodiment, when the user is not a slang policy target (it is determined as “no”), the electronic device 101 may perform operation 360. In an embodiment, when the user is a slang policy target (it is determined as “yes”), the electronic device 101 may perform operation 420.

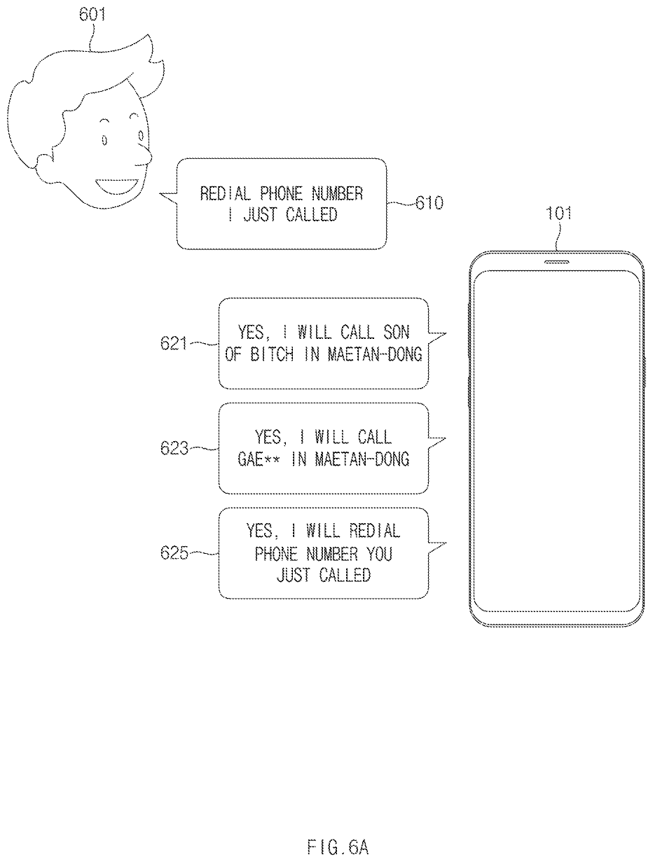

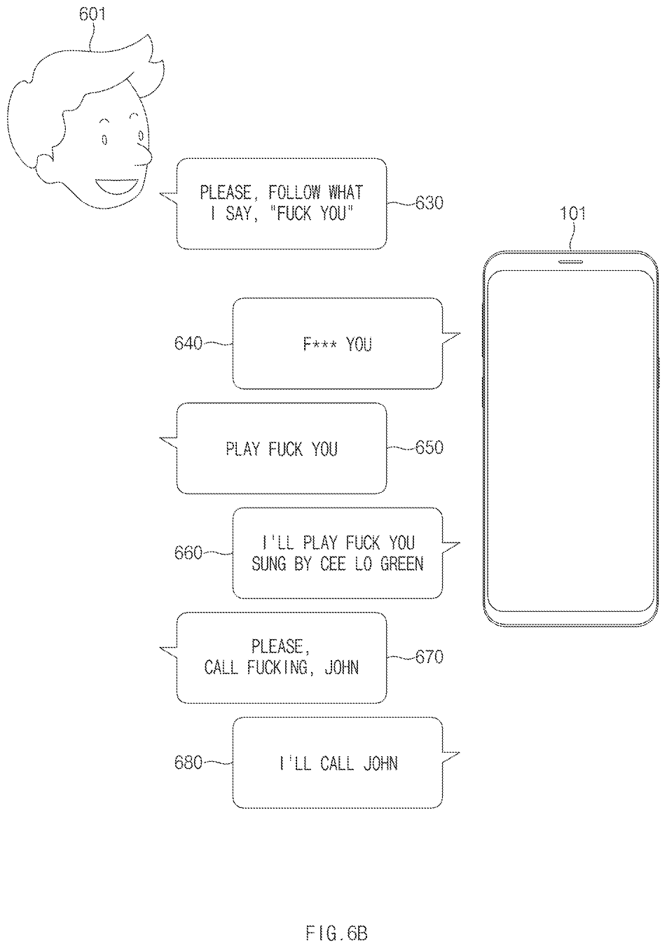

FIG. 6A is a diagram illustrating a response of the electronic device 101, according to an embodiment of the disclosure. The electronic device 101 of FIG. 6A may correspond to the electronic device 101 of FIG. 2.

Referring to FIG. 6A, a user 601 may provide the electronic device 101 with an input 610 of “redial the phone number I just called”.

In an embodiment, the electronic device 101 may generate a plan for redialing the phone number just called based on the input 610, and may perform a plurality of actions by using the generated plan. In an embodiment, the electronic device 101 may make a call to the phone number just called, depending on a result of performing a plurality of actions.

In an embodiment, the electronic device 101 may provide a user with a response before making a call.

In an embodiment, the electronic device 101 may identify a name (“a son of a bitch in Maetan-dong”) associated with the phone number just called, from an address book. Referring to FIG. 6A, the electronic device 101 may generate a first output 621 saying that “Yes, I will call the son of a bitch in Maetan-dong” based on the identification result.

In an embodiment, the electronic device 101 may detect a slang word from the first output 621. For example, the electronic device 101 may detect the “son of a bitch” as a slang word from the first output 621.

In an embodiment, the electronic device 101 may generate a second output 623 saying that “Yes, I will call gae** in Maetan-dong” or a second output 625 saying that “Yes, I will redial the phone number you just called”, based on a slang processing method.

In an embodiment, the electronic device 101 may provide the generated second output 623 or 625 to the user 601.

FIG. 6B is a diagram illustrating a response according to different slang processing methods of the electronic device 101, according to an embodiment of the disclosure. The electronic device 101 of FIG. 6B may correspond to the electronic device 101 of FIG. 2.

Referring to FIG. 6B, the user 601 may provide an input 630 of “please, follow what I say, ‘FUCK YOU’” to the electronic device 101. In an embodiment, the electronic device 101 may generate “FUCK YOU” as a first output for the input 630. In an embodiment, the electronic device 101 may detect “FUCK” as a slang word from “FUCK YOU”. In an embodiment, the electronic device 101 may generate a second output 640 of “F*** YOU” based on a slang processing method. In an embodiment, the electronic device 101 may provide the second output 640 to the user 601.

Referring to FIG. 6B, the user 601 may provide an input 650 of “play FUCK YOU” to the electronic device 101. In an embodiment, the electronic device 101 may generate “I'll play Fuck You sung by Cee Lo Green” as the first output 660 for the input 650. In an embodiment, when a slang word for the name of content is permitted, the electronic device 101 may provide the first output 660 to the user 601. In an embodiment, the user 601 may provide an input 670 of “please, call FUCKING, John” to the electronic device 101. In an embodiment, the electronic device 101 may generate “I'll call John” as the first output 680 for the input 670. In an embodiment, the electronic device 101 may provide the first output 680 to the user 601.

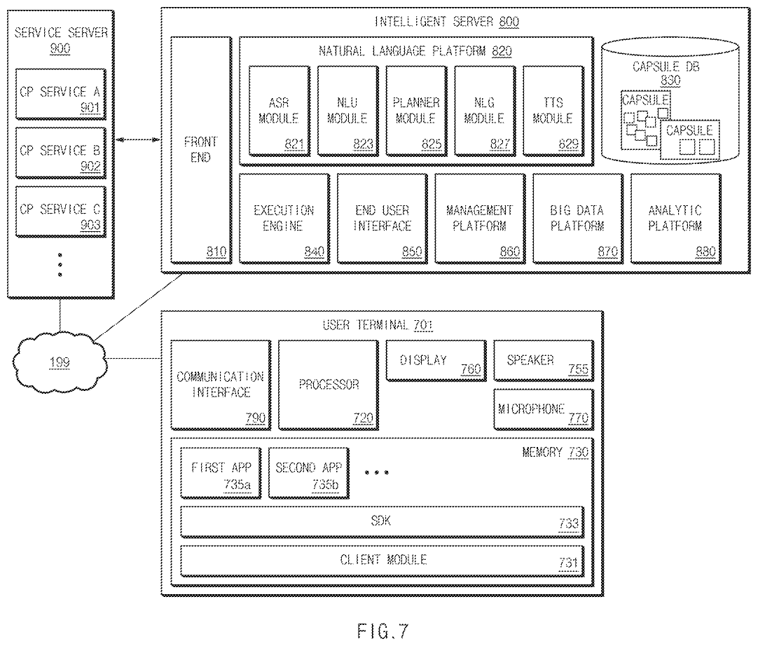

FIG. 7 is a block diagram illustrating an integrated intelligence system, according to an embodiment of the disclosure.

Referring to FIG. 7, an integrated intelligence system according to an embodiment may include a user terminal 701, an intelligence server 800, and a service server 900.

The user terminal 701 (e.g., the electronic device 101 of FIG. 1) according to an embodiment may be a terminal device (or an electronic device) capable of connecting to Internet, and may be, for example, a mobile phone, a smailphone, a personal digital assistant (PDA), a notebook computer, a television (TV), a household appliance, a wearable device, a head mounted display (HMD), or a smart speaker.

According to the illustrated embodiment, the user terminal 701 may include a communication interface 790, a microphone 770, a speaker 755, a display 760, a memory 730, and/or a processor 720. The listed components may be operatively or electrically connected to one another.

The communication interface 790 (e.g., the communication module 190 of FIG. 1) may be connected to an external device and may be configured to transmit or receive data to or from the external device. The microphone 770 (e.g., the audio module 170 of FIG. 1) may receive a sound (e.g., a user utterance) to convert the sound into an electrical signal. The speaker 755 (e.g., the sound output module 155 of FIG. 1) may output the electrical signal as sound (e.g., voice). The display 760 (e.g., the display module 160 of FIG. 1) may be configured to display an image or video. The display 760 according to an embodiment may display the graphic user interface (GUI) of the running app (or an application program).

The memory 730 (e.g., the memory 130 of FIG. 1) according to an embodiment may store a client module 731, a software development kit (SDK) 733, and a plurality of applications. The client module 731 and the SDK 733 may constitute a framework (or a solution program) for performing general-purposed functions. Furthermore, the client module 731 or the SDK 733 may constitute the framework for processing a voice input.

The plurality of applications (e.g., 755a, 755b) may be programs for performing a specified function. According to an embodiment, the plurality of applications may include a first app 735a and/or a second app 735b. According to an embodiment, each of the plurality of applications may include a plurality of actions for performing a specified function. For example, the applications may include an alarm app, a message app, and/or a schedule app. According to an embodiment, the plurality of applications may be executed by the processor 720 to sequentially execute at least part of the plurality of actions.

According to an embodiment, the processor 720 may control overall operations of the user terminal 701. For example, the processor 720 may be electrically connected to the communication interface 790, the microphone 770, the speaker 755, and the display 760 to perform a specified operation. For example, the processor 720 may include at least one processor.

Moreover, the processor 720 according to an embodiment may execute the program stored in the memory 730 so as to perform a specified function. For example, according to an embodiment, the processor 720 may execute at least one of the client module 731 or the SDK 733 so as to perform a following operation for processing a voice input. The processor 720 may control operations of the plurality of applications via the SDK 733. The following actions described as the actions of the client module 731 or the SDK 733 may be the actions performed by the execution of the processor 720.

According to an embodiment, the client module 731 may receive a voice input. For example, the client module 731 may receive a voice signal corresponding to a user utterance detected through the microphone 770. The client module 731 may transmit the received voice input (e.g., a voice input) to the intelligence server 800. The client module 731 may transmit state information of the user terminal 701 to the intelligence server 800 together with the received voice input. For example, the state information may be execution state information of an app.

According to an embodiment, the client module 731 may receive a result corresponding to the received voice input from the intelligence server 800. For example, when the intelligence server 800 is capable of calculating the result corresponding to the received voice input, the client module 731 may receive the result corresponding to the received voice input. The client module 731 may display the received result on the display 760.

According to an embodiment, the client module 731 may receive a plan corresponding to the received voice input. The client module 731 may display, on the display 760, a result of executing a plurality of actions of an app depending on the plan. For example, the client module 731 may sequentially display the result of executing the plurality of actions on a display. As another example, the user terminal 701 may display only a part of results (e.g., a result of the last action) of executing the plurality of actions, on the display.

According to an embodiment, the client module 731 may receive a request for obtaining information necessary to calculate the result corresponding to a voice input, from the intelligence server 800. According to an embodiment, the client module 731 may transmit the necessary information to the intelligence server 800 in response to the request.

According to an embodiment, the client module 731 may transmit, to the intelligence server 800, information about the result of executing a plurality of actions depending on the plan. The intelligence server 800 may identify that the received voice input is correctly processed, using the result information.

According to an embodiment, the client module 731 may include a speech recognition module. According to an embodiment, the client module 731 may recognize a voice input for performing a limited function, via the speech recognition module. For example, the client module 731 may launch an intelligence app for processing a specific voice input by performing an organic action, in response to a specified voice input (e.g., wake up!).

According to an embodiment, the intelligence server 800 may receive information associated with a user's voice input from the user terminal 701 over a network 799 (e.g., the first network 198 and/or the second network 199 of FIG. 1). According to an embodiment, the intelligence server 800 may convert data associated with the received voice input to text data. According to an embodiment, the intelligence server 800 may generate at least one plan for performing a task corresponding to the user's voice input, based on the text data.

According to an embodiment, the plan may be generated by an artificial intelligent (AI) system. The AI system may be a rule-based system, or may be a neural network-based system (e.g., a feedforward neural network (FNN) and/or a recurrent neural network (RNN)). Alternatively, the AI system may be a combination of the above-described systems or an AI system different from the above-described system. According to an embodiment, the plan may be selected from a set of predefined plans or may be generated in real time in response to a user's request. For example, the AI system may select at least one plan of the plurality of predefined plans.

According to an embodiment, the intelligence server 800 may transmit a result according to the generated plan to the user terminal 701 or may transmit the generated plan to the user terminal 701. According to an embodiment, the user terminal 701 may display the result according to the plan, on a display. According to an embodiment, the user terminal 701 may display a result of executing the action according to the plan, on the display.

The intelligence server 800 according to an embodiment may include a front end 810, a natural language platform 820, a capsule DB 830, an execution engine 840, an end user interface 850, a management platform 860, a big data platform 870, or an analytic platform 880.

The front end 810 according to an embodiment may receive a voice input received by the user terminal 701 from the user terminal 701. The front end 810 may transmit a response corresponding to the voice input to the user terminal 701.

According to an embodiment, the natural language platform 820 may include an automatic speech recognition (ASR) module 821, a NLU module 823, a planner module 825, a NLG module 827, and/or a text to speech module (TTS) module 829.

According to an embodiment, the ASR module 821 may convert the voice input received from the user terminal 701 into text data. According to an embodiment, the NLU module 823 may grasp the intent of the user, using the text data of the voice input. For example, the NLU module 823 may grasp the intent of the user by performing syntactic analysis and/or semantic analysis. According to an embodiment, the NLU module 823 may grasp the meaning of words extracted from the voice input by using linguistic features (e.g., syntactic elements) such as morphemes or phrases and may determine the intent of the user by matching the grasped meaning of the words to the intent.

According to an embodiment, the planner module 825 may generate the plan by using a parameter and the intent that is determined by the NLU module 823. According to an embodiment, the planner module 825 may determine a plurality of domains necessary to perform a task, based on the determined intent. The planner module 825 may determine a plurality of actions included in each of the plurality of domains determined based on the intent. According to an embodiment, the planner module 825 may determine the parameter necessary to perform the determined plurality of actions or a result value output by the execution of the plurality of actions. The parameter and the result value may be defined as a concept of a specified form (or class). As such, the plan may include the plurality of actions and/or a plurality of concepts, which are determined by the intent of the user. The planner module 825 may determine the relationship between the plurality of actions and the plurality of concepts stepwise (or hierarchically). For example, the planner module 825 may determine the execution sequence of the plurality of actions, which are determined based on the user's intent, based on the plurality of concepts. In other words, the planner module 825 may determine an execution sequence of the plurality of actions, based on the parameters necessary to perform the plurality of actions and the result output by the execution of the plurality of actions. Accordingly, the planner module 825 may generate a plan including information (e.g., ontology) about the relationship between the plurality of actions and the plurality of concepts. The planner module 825 may generate the plan by using information stored in the capsule DB 830 storing a set of relationships between concepts and actions.

According to an embodiment, the NLG module 827 may change specified information into information in a text form. The information changed to the text form may be in the form of a natural language speech. The TTS module 829 according to an embodiment may change information in the text form to information in a voice form.

According to an embodiment, all or part of the functions of the natural language platform 820 may be also implemented in the user terminal 701. For example, the user terminal 701 may include an ASR module and/or an NLU module. The user terminal 701 may recognize the user's voice command and then may transmit text information corresponding to the recognized voice command to the intelligence server 800. For example, the user terminal 701 may include a TTS module. The user terminal 701 may receive text information from the intelligence server 800 and may output the received text information by using voice.

The capsule DB 830 may store information about the relationship between the actions and the plurality of concepts corresponding to a plurality of domains. According to an embodiment, the capsule may include a plurality of action objects (or action information) and/or concept objects (or concept information) included in the plan. According to an embodiment, the capsule DB 830 may store the plurality of capsules in a form of a concept action network (CAN). According to an embodiment, the plurality of capsules may be stored in the function registry included in the capsule DB 830.

The capsule DB 830 may include a strategy registry that stores strategy information necessary to determine a plan corresponding to a voice input. When there are a plurality of plans corresponding to the voice input, the strategy information may include reference information for determining one plan. According to an embodiment, the capsule DB 830 may include a follow-up registry that stores information of the follow-up action for suggesting a follow-up action to the user in a specified context. For example, the follow-up action may include a follow-up utterance. According to an embodiment, the capsule DB 830 may include a layout registry storing layout information of information output via the user terminal 701. According to an embodiment, the capsule DB 830 may include a vocabulary registry storing vocabulary information included in capsule information. According to an embodiment, the capsule DB 830 may include a dialog registry storing information about dialog (or interaction) with the user. The capsule DB 830 may update an object stored via a developer tool. For example, the developer tool may include a function editor for updating an action object or a concept object. The developer tool may include a vocabulary editor for updating a vocabulary. The developer tool may include a strategy editor that generates and registers a strategy for determining the plan. The developer tool may include a dialog editor that creates a dialog with the user. The developer tool may include a follow-up editor capable of activating a follow-up target and editing the follow-up utterance for providing a hint. The follow-up target may be determined based on a target, the user's preference, or an environment condition, which is currently set. According to an embodiment, the capsule DB 830 may be implemented in the user terminal 701.

According to an embodiment, the execution engine 840 may calculate a result by using the generated plan. The end user interface 850 may transmit the calculated result to the user terminal 701. Accordingly, the user terminal 701 may receive the result and may provide the user with the received result. According to an embodiment, the management platform 860 may manage information used by the intelligence server 800. According to an embodiment, the big data platform 870 may collect data of the user. According to an embodiment, the analytic platform 880 may manage quality of service (QoS) of the intelligence server 800. For example, the analytic platform 880 may manage the component and processing speed (or efficiency) of the intelligence server 800.

According to an embodiment, the service server 900 may provide the user terminal 701 with a specified service (e.g., ordering food or booking a hotel). According to an embodiment, the service server 900 may be a server operated by the third party. According to an embodiment, the service server 900 may provide the intelligence server 800 with information for generating a plan corresponding to the received voice input. The provided information may be stored in the capsule DB 830. Furthermore, the service server 900 may provide the intelligence server 800 with result information according to the plan. The service server 900 may communicate with the intelligence server 800 and/or the user terminal 701 over the network 799. The service server 900 may communicate with the intelligence server 800 through a separate connection. An example is illustrated in FIG. 7 as the service server 900 is one server, but embodiments of the disclosure are not limited thereto. At least one of the respective services 901, 902, and 903 of the service server 900 may be implemented with a separate server.

In the above-described integrated intelligence system, the user terminal 701 may provide the user with various intelligent services in response to a user input. The user input may include, for example, an input through a physical button, a touch input, or a voice input.

According to an embodiment, the user terminal 701 may provide a speech recognition service via an intelligence app (or a speech recognition app) stored therein. For example, the user terminal 701 may recognize a user utterance or a voice input, which is received via the microphone, and may provide the user with a service corresponding to the recognized voice input.

According to an embodiment, the user terminal 701 may perform a specified action, based on the received voice input, independently, or together with the intelligence server and/or the service server. For example, the user terminal 701 may launch an app corresponding to the received voice input and may perform the specified action via the executed app.

In an embodiment, when providing a service together with the intelligence server 800 and/or the service server, the user terminal 701 may detect a user utterance by using the microphone 770 and may generate a signal (or voice data) corresponding to the detected user utterance. The user terminal may transmit the voice data to the intelligence server 800 by using the communication interface 790.

According to an embodiment, the intelligence server 800 may generate a plan for performing a task corresponding to the voice input or the result of performing an action depending on the plan, as a response to the voice input received from the user terminal 701. For example, the plan may include a plurality of actions for performing the task corresponding to the voice input of the user and/or a plurality of concepts associated with the plurality of actions. The concept may define a parameter to be entered upon executing the plurality of actions or a result value output by the execution of the plurality of actions. The plan may include relationship information between the plurality of actions and the plurality of concepts.

According to an embodiment, the user terminal 701 may receive the response by using the communication interface 790. The user terminal 701 may output the voice signal generated in the user terminal 701 to the outside by using the speaker 755 or may output an image generated in the user terminal 701 to the outside by using the display 760.

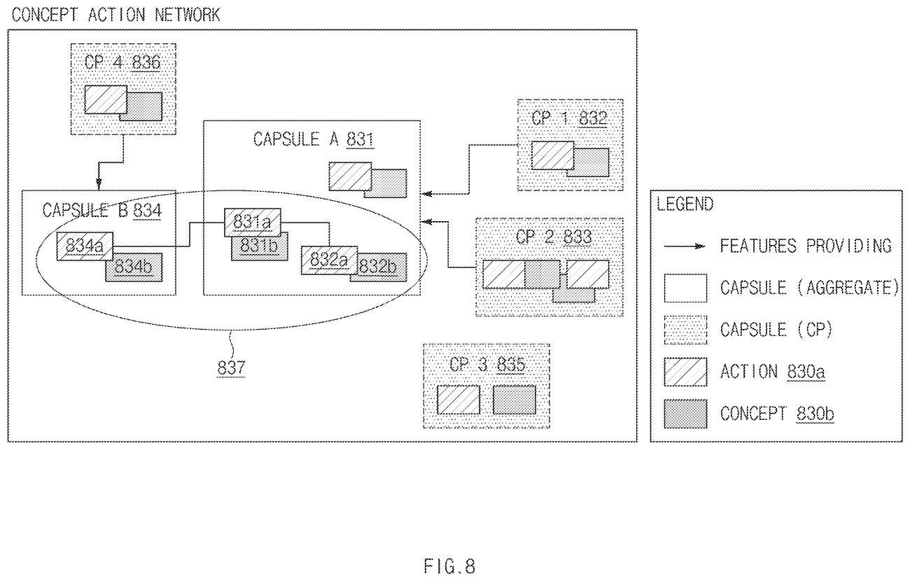

FIG. 8 is a diagram illustrating a form in which relationship information between a concept and an action is stored in a database, according to an embodiment of the disclosure.

A capsule database (e.g., the capsule DB 830) of the intelligence server 800 may store a capsule in the form of a CAN. The capsule DB may store an action for processing a task corresponding to a user's voice input and a parameter necessary for the action, in the CAN form.

The capsule DB may store a plurality capsules (a capsule A 831 and a capsule B 834) respectively corresponding to a plurality of domains (e.g., applications). According to an embodiment, a single capsule (e.g., the capsule A 831) may correspond to a single domain (e.g., a location (geo) or an application). In addition, one capsule may correspond to a capsule (e.g., CP 1 832, CP 2 833, CP 3 835, and/or CP 4 836) of at least one service provider for performing a function for a domain associated with a capsule. According to an embodiment, the one capsule may include at least one or more actions 830a and at least one or more concepts 830b for performing a specified function.

The natural language platform 820 may generate a plan for performing a task corresponding to the received voice input by using the capsule stored in the capsule DB 830. For example, the planner module 825 of the natural language platform may generate the plan by using the capsule stored in the capsule database. For example, a plan 837 may be generated by using actions 831a and 832a and concepts 831b and 832b of the capsule A 831 and an action 834a and a concept 834b of the capsule B 834.

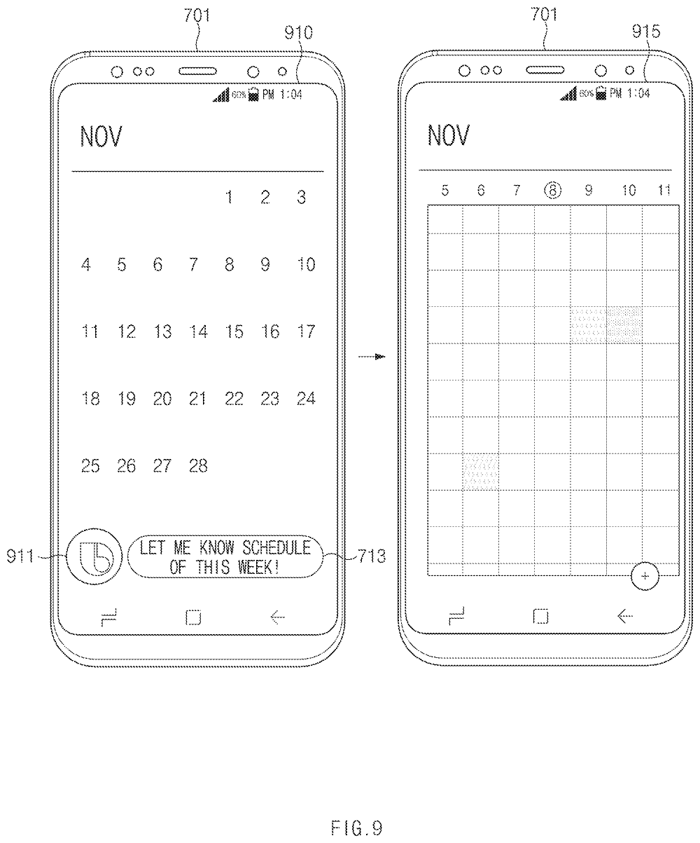

FIG. 9 is a view illustrating a screen in which a user terminal processes a voice input received through an intelligence app, according to an embodiment of the disclosure.

The user terminal 701 may execute an intelligence app to process a user input through the intelligence server 800.

According to an embodiment, on first screen 910, when recognizing a specified voice input (e.g., wake up!) or receiving an input via a hardware key (e.g., a dedicated hardware key), the user terminal 701 may launch an intelligence app for processing a voice input. For example, the user terminal 701 may launch the intelligence app in a state where a schedule app is executed. According to an embodiment, the user terminal 701 may display an object (e.g., an icon) 911 corresponding to the intelligence app, on the display. According to an embodiment, the user terminal 701 may receive a voice input by a user utterance. For example, the user terminal 701 may receive a voice input saying that “let me know the schedule of this week!”. According to an embodiment, the user terminal 701 may display a user interface (UI) 713 (e.g., an input window) of the intelligence app, in which text data of the received voice input is displayed, on a display.

According to an embodiment, on second screen 915, the user terminal 701 may display a result corresponding to the received voice input, on the display. For example, the user terminal 701 may receive a plan corresponding to the received user input and may display ‘the schedule of this week’ on the display depending on the plan.

According to an embodiment, an electronic device 101 may include a processor 120, and a memory 130 that stores instructions. The instructions, when executed by the processor 120, may cause the electronic device to receive a user input, to identify a natural language input corresponding to the user input, to identify a first natural language output corresponding to the natural language input, to identify at least one specified word from at least one word included in the first natural language output, to identify a second natural language output based on a fact that the at least one specified word is identified, and to output the second natural language output such that the second natural language output is provided to a user.

In an embodiment, the instructions may, when executed by the processor 120, cause the electronic device to identify a plan based on the natural language input and to identify the at least one specified word from the at least one word based on at least one capsule associated with the plan.

In an embodiment, the instructions may, when executed by the processor 120, cause the electronic device to output the first natural language output such that the first natural language output is provided to the user when the at least one capsule permits use of a slang word.

In an embodiment, the instructions may, when executed by the processor 120, cause the electronic device to identify the second natural language output by processing the at least one specified word in the first natural language output based on a slang processing method of at least one capsule associated with the plan.

In an embodiment, the instructions may, when executed by the processor 120, cause the electronic device to identify a word, which is permitted, from among the at least one word based on the at least one capsule and to identify the second natural language output by processing a remaining specified word other than the permitted word in the at least one specified word.

In an embodiment, the permitted word may include a name of content.

In an embodiment, a method for processing the at least one specified word includes replacement of the at least one specified word, screening for the at least one specified word, deletion of the at least one specified word, or a combination of the replacement of the at least one specified word, the screening for the at least one specified word, and the deletion of the at least one specified word.

In an embodiment, the instructions may, when executed by the processor 120, cause the electronic device to identify that the user of the electronic device is a target of a slang policy, based on the at least one capsule and to identify the at least one specified word from the at least one word when the user is the target of the slang policy.

In an embodiment, the instructions may, when executed by the processor 120, cause the electronic device to identify the at least one specified word from the at least one word included in the first natural language output based on each of the two or more capsules when the at least one capsule corresponds to two or more capsules.

In an embodiment, the instructions may, when executed by the processor 120, cause the electronic device to identify that a word, which is not permitted by all of the two or more capsules, is the at least one specified word.

According to an embodiment, an operating method of the electronic device 101 may include receiving a user input, identifying a natural language input corresponding to the user input, identifying a first natural language output corresponding to the natural language input, identifying at least one specified word from at least one word included in the first natural language output, identifying a second natural language output based on a fact that the at least one specified word is identified, and outputting the second natural language output such that the second natural language output is provided to a user.

According to an embodiment, an operating method of the electronic device 101 may include identifying a plan based on the natural language input and identifying the at least one specified word from the at least one word based on at least one capsule associated with the plan.

According to an embodiment, an operating method of the electronic device 101 may include outputting the first natural language output such that the first natural language output is provided to the user when the at least one capsule permits use of a slang word.

In an embodiment, the identifying of the second natural language output may include identifying the second natural language output by processing the at least one specified word in the first natural language output based on a slang processing method of at least one capsule associated with the plan.

In an embodiment, the identifying of the second natural language output may include identifying a word, which is permitted, from among the at least one word based on the at least one capsule and identifying the second natural language output by processing a remaining specified word other than the permitted word in the at least one specified word.

In an embodiment, the permitted word may include a name of content.

In an embodiment, a method for processing the at least one specified word includes replacement of the at least one specified word, screening for the at least one specified word, deletion of the at least one specified word, or a combination of the replacement of the at least one specified word, the screening for the at least one specified word, and the deletion of the at least one specified word.

In an embodiment, the identifying of at least one specified word may include identifying that the user of the electronic device is a target of a slang policy, based on the at least one capsule and identifying the at least one specified word from the at least one word when the user is the target of the slang policy.

In an embodiment, the identifying of at least one specified word may include identifying the at least one specified word from the at least one word included in the first natural language output based on each of the two or more capsules when the at least one capsule corresponds to two or more capsules.

In an embodiment, the identifying of at least one specified word may include identifying that a word, which is not permitted by all of the two or more capsules, is the at least one specified word.

In an embodiment, the identifying of the natural language input corresponding to the user input includes converting the user input into text data.

In an embodiment, the first natural language output is based on intent of the user input.

In an embodiment, the first natural language output includes an indication of whether to execute a plan according to the user input.

In an embodiment, the method further comprises determining a slang policy target for the user input based on target profile information.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a processor, and
a memory configured to store instructions,
wherein the instructions, when executed by the processor, cause the electronic device to:
receive a user input,
identify a natural language input corresponding to the user input,
identify a first natural language output corresponding to the natural language input,
identify at least one specified word from at least one word included in the first natural language output,
identify a second natural language output based on a fact that the at least one specified word is identified, and
output the second natural language output such that the second natural language output is provided to a user.

2. The electronic device of claim 1, wherein the instructions, when executed by the processor, cause the electronic device to:
identify a plan based on the natural language input, and
identify the at least one specified word from the at least one word based on at least one capsule associated with the plan.

3. The electronic device of claim 2, wherein the instructions, when executed by the processor, cause the electronic device to:
when the at least one capsule permits use of a slang word, output the first natural language output such that the first natural language output is provided to the user.

4. The electronic device of claim 2, wherein the instructions, when executed by the processor, cause the electronic device to:
identify the second natural language output by processing the at least one specified word in the first natural language output based on a slang processing method of at least one capsule associated with the plan.

5. The electronic device of claim 4, wherein the instructions, when executed by the processor, cause the electronic device to:
identify a word, which is permitted, from among the at least one word based on the at least one capsule, and
identify the second natural language output by processing a remaining specified word other than the permitted word in the at least one specified word.

6. The electronic device of claim 5, wherein the permitted word includes a name of content.

7. The electronic device of claim 4, wherein the processing of the at least one specified word includes replacing the at least one specified word, screening for the at least one specified word, deleting the at least one specified word, or a combination of the replacing of the at least one specified word, the screening for the at least one specified word, and the deleting of the at least one specified word.

8. The electronic device of claim 2, wherein the instructions, when executed by the processor, cause the electronic device to:
identify that the user of the electronic device is a target of a slang policy, based on the at least one capsule, and
when the user is the target of the slang policy, identify the at least one specified word from the at least one word.

9. The electronic device of claim 2, wherein the instructions, when executed by the processor, cause the electronic device to:
when the at least one capsule corresponds to two or more capsules, identify the at least one specified word from the at least one word included in the first natural language output based on each of the two or more capsules.

10. The electronic device of claim 9, wherein the instructions, when executed by the processor, cause the electronic device to:
identify that a word, which is not permitted by all of the two or more capsules, is the at least one specified word.

11. An operating method of an electronic device, the method comprising:
receiving a user input;
identifying a natural language input corresponding to the user input;
identifying a first natural language output corresponding to the natural language input;
identifying at least one specified word from at least one word included in the first natural language output;
identifying a second natural language output based on a fact that the at least one specified word is identified; and
outputting the second natural language output such that the second natural language output is provided to a user.

12. The method of claim 11, comprising:
identifying a plan based on the natural language input; and
identifying the at least one specified word from the at least one word based on at least one capsule associated with the plan.

13. The method of claim 12, comprising:
when the at least one capsule permits use of a slang word, outputting the first natural language output such that the first natural language output is provided to the user.

14. The method of claim 12, wherein the identifying of the second natural language output includes:
identifying the second natural language output by processing the at least one specified word in the first natural language output based on a slang processing method of at least one capsule associated with the plan.

15. The method of claim 14, wherein the identifying of the second natural language output includes:
identifying a word, which is permitted, from among the at least one word based on the at least one capsule; and
identifying the second natural language output by processing a remaining specified word other than the permitted word in the at least one specified word.

16. The method of claim 15, wherein the permitted word includes a name of content.

17. The method of claim 14, wherein the processing of the at least one specified word includes replacing the at least one specified word, screening for the at least one specified word, deleting the at least one specified word, or a combination of the replacing of the at least one specified word, the screening for the at least one specified word, and the deleting of the at least one specified word.

18. The method of claim 12, wherein the identifying of at least one specified word includes:
identifying that the user of the electronic device is a target of a slang policy, based on the at least one capsule; and
when the user is the target of the slang policy, identifying the at least one specified word from the at least one word.

19. The method of claim 12, wherein the identifying of at least one specified word includes:
when the at least one capsule corresponds to two or more capsules, identifying the at least one specified word from the at least one word included in the first natural language output based on each of the two or more capsules.

20. The method of claim 19, wherein the identifying of at least one specified word includes:
identifying that a word, which is not permitted by all of the two or more capsules, is the at least one specified word.
